(19) United States
(12) Patent Application Publication
(10) Pub. No.: US 2005/0019553 A1
(43) Pub. Date: Jan. 27, 2005

(54) Ceramic sintered bodies

(75) Inventor: Hirotake Yamada, Anjo-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/885,396

(22) Filed: Jul. 6, 2004

(30) Foreign Application Priority Data
Jul. 24, 2003 (JP) 2003-278865

(51) Int. Cl. B32B 9/00

(52) U.S. Cl. 428/325; 428/332; 428/701; 428/323

(57) ABSTRACT

Ceramic sintered bodies 1, 11 have first phases 3, 13 and second phases 2, 12, respectively. The first and second phases contact each other. The first phase has a thickness “TA” larger than the thickness “TB” of the second phase. 80 percent or more of particles constituting the first phase have diameters in a range of 0.2 to 3 μm, and 80 percent or more of particles constituting the second phase have diameters in a range of 0.3 to 3 μm.

This application claims the benefits of Japanese Patent Applications P2003-278865 filed on Jul. 24, 2003, the entirety of which is incorporated by reference.

### BACKGROUND OF THE INVENTION

1. Field of the Invention

The present invention relates to a ceramic sintered body.

2. Related Art Statement

In a semiconductor manufacturing system in which a super-clean state is necessary, as a deposition gas, an etching gas and a cleaning gas, halogen-based corrosive gases such as chlorine-based gases and fluorine-based gases have been used. For instance, in a semiconductor manufacturing system such as thermal CVD system, after the deposition, semiconductor cleaning gases composed of halogen-based corrosive gases such as ClF₃, NF₃, CF₄, HF and HCl are used. Furthermore, in a step of the deposition, halogen-based corrosive gases such as WF₆, SiH₂Cl₂ and so on are used as gases for use in film deposition.

Accordingly, it is desired that members for use in a semiconductor manufacturing apparatus, for instance, members that are accommodated in the apparatus and an inner wall surface of a chamber are provided with a coating high in the corrosion-resistance against a halogen gas and its plasma and stable over a long period of time.

### SUMMARY OF THE INVENTION

The assignee disclosed, in JP 2002-249864A, that when an yttria-alumina garnet film is formed on a surface of a substrate by use of a spraying method, excellent corrosion resistance against plasma of a halogen gas can be endowed and particles can be suppressed from generating.

However, even in the film, in some cases, the following problems are caused. That is, depending on spraying conditions, it is difficult to form a film having a constant thickness, so that the thickness of the sprayed film may be substantially deviated depending on the positions. If the thickness of the sprayed film is deviated, the properties of the film such as thermal conduction is deviated, so that the stress distribution in the film may be substantially induced leading to the peeling off of the film. Further, according to a spraying method, it is difficult to provide a film having a thickness larger than a specific value. For example, it is extremely difficult to form a sprayed film having a thickness of 0.5 mm or more.

An object of the present invention is to provide a ceramic sintered body having at least first and second phases contacting one another at an interface, so that the thickness of the phase can be increased and peeling-off of the first and second phases and crack formation can be prevented.

A first aspect of the present invention provides a ceramic sintered body comprising first and second phases contacting each other. The first phase has a thickness larger than that of the second phase. 80 percent or more of particles constituting the first phase have diameters in a range of 0.2 to 3 μm, and 80 percent or more of particles constituting the second phase have diameters in a range of 0.3 to 3 μm.

A second phase of the present invention provides a ceramic sintered body comprising first and second phases contacting each other. The first phase has a fracture strength larger than that of the second phase. 80 percent or more of particles constituting the first phase have diameters in a range of 0.2 to 3 μm, and 80 percent or more of particles constituting the second phase have diameters in a range of 0.3 to 3 μm.

The inventors have reached the idea that, in a ceramic sintered body having first and second phases where the first phase has a larger thickness or higher fracture strength, the diameters of 80 percent or more of particles constituting the first phase is made within a range of 0.2 to 3 μm, and the diameters of 80 percent or more of particles constituting the second phase is made within a range of 0.3 to 3 μm. It is thus possible to make the second phase thicker and to prevent the peeling of the second phase from the first phase and the crack formation.

These and other objects, features and advantages of the invention will be appreciated upon reading the following description of the invention when taken in conjunction with the attached drawings, with the understanding that some modifications, variations and changes of the same could be made by the skilled person in the art.

### BRIEF DESCRIPTION OF THE DRAWINGS

FIG. 1(a) is a front view schematically showing a composite sintered body 1.

FIG. 1(b) is a front view schematically showing a composite sintered body 11.

FIG. 2 is a flow chart of a manufacturing process according to one embodiment of the present invention.

FIG. 3 is a flow chart of a manufacturing process according to another embodiment of the present invention.

FIG. 4 is a flow chart of a manufacturing process according to still another embodiment of the present invention.

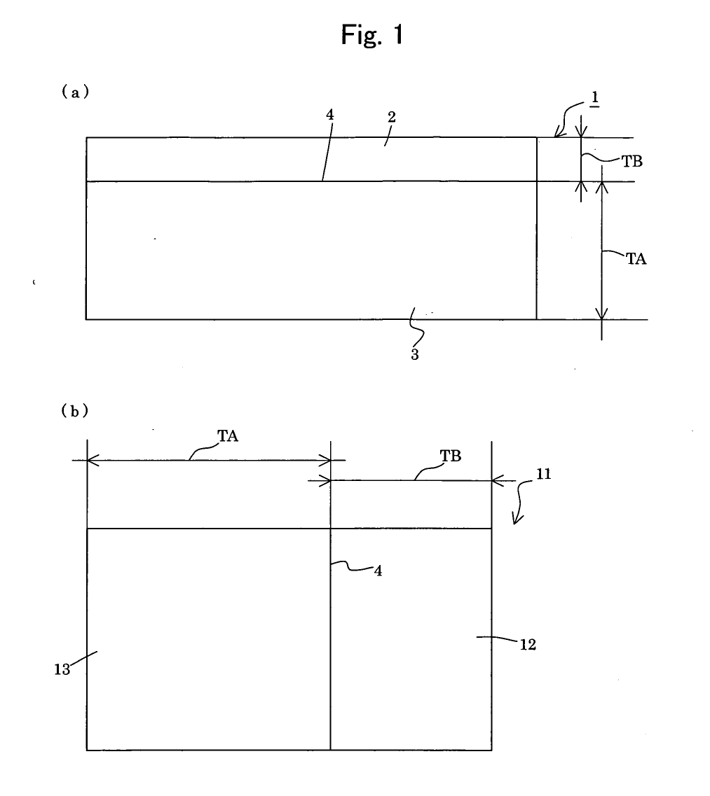

The shape of the first or second phase is not particularly limited. In a preferred embodiment, the sintered body of the invention has a substrate 3 and a film 2 laminated on the substrate, as shown in FIG. 1(a). In this embodiment, the substrate 3 is assigned to the first phase and the film 2 is assigned to the second phase. Alternatively, the first phase 13 and second phase 12 may be bulky bodies integrated with each other, as shown in FIG. 1(b).

The sintered body according to the present invention may have one or more additional sintered phase other than the first and second phases. The additional sintered phases may have any shape or form not particularly limited. The additional sintered phase may preferably be laminated with the first and second phases. The additional sintered phase may be adjacent with the first phase, or with the second phase, or with both of the first and second phases.

According to the first aspect of the present invention, the thickness of the first phase is larger than that of the second phase. The thickness of the first or second phase means a dimension of the first or second phase in the direction substantially perpendicular to the interface of the phases. For example in FIG. 1(a), the dimension “TA” or “TB” of the first phase 3 or second phase 2 in the direction substantially perpendicular to the interface 4 means the thickness of each phase. Further in the example of FIG. 1(b), the dimension “TA” or “TB” of the first phase 13 or second phase 12 in the direction substantially perpendicular to the interface 4 means the thickness of each phase.

According to the first aspect of the present invention, the thickness of the first phase may preferably be 0.5 mm or more, more preferably 1 mm or more and most preferably 5 mm or more, on the viewpoint of ease of handling of the shaped body. The upper limit of the thickness of the first phase is not defined. The thickness of the first phase in a direction where the dimension of the phase is smallest may preferably be 100 mm or smaller.

According to the first aspect of the present invention, the thickness of the second phase may preferably be 0.5 mm or more, on the viewpoint of fully utilizing the characteristics of the second phase. The upper limit of the thickness of the second phase is not defined. A total of the thickness of the first phase and that of the second phase may preferably be 1 mm or larger. The upper limit of the total thickness is not particularly defined, and for example 100 mm or smaller, and more preferably be 30 mm or smaller. Further, the ratio of the thickness of the first phase to the thickness of the second phase (thickness of first phase/thickness of second phase) may preferably be 2 or higher, and more preferably be 5 or higher.

According to the second aspect of the present invention, each fracture strength of the first or second phase means each fracture strength of each of the first and second phases after they are separated.

According to the first and second aspects of the present invention, 80 percent or more of particles constituting the first phase have diameters in a range of 0.2 to 3 μm. On the viewpoint of the present invention, it is preferred that 90 percent or more of particles constituting the first phase have diameters in a range of 0.2 to 3 μm. Further, according to the first and second aspects of the present invention, 80 percent or more of particles constituting the second phase have diameters in a range of 0.3 to 3 μm. On the viewpoint of the present invention, it is preferred that 90 percent or more of particles constituting the second phase have diameters in a range of 0.3 to 3 μm.

The first and second phases may be made of the same or different materials with each other. It is, however, preferred that the first and second phases are made of the different materials.

Ceramic materials for the first and second phases include an oxide series ceramics such as alumina, zirconia, titania, silica, magnesia, ferrite, cordielite and oxides of rare elements such as yttria; a composite oxides such as barium titanate, strontium titanate, lead zirconate titanate, manganites of rare earth elements and chromites of rare earth elements; a nitride series ceramics such as aluminum nitride, silicon nitride and sialon; a carbide series ceramics such as silicon carbide, boron carbide, and tungsten carbide; and a fluoride series ceramics such as beryllium fluoride, magnesium fluoride, calcium fluoride, strontium fluoride, barium fluoride and so on.

The first and second aspects of the present invention is particularly suitable for the following materials. That is, one of the first and second phases is made of a ceramic containing alumina, and the other is made of a ceramics containing an yttria-alumina composite oxide.

In the ceramics containing an yttria-alumina composite oxide, the composite oxide includes the followings.
Y₃Al₅O₁₂ (YAG: 3Y₂O₃.5Al2O₃) (1)

This contains yttria and alumina in a proportion of 3:5, and has garnet crystal structure.
YAlO₃ (YAL: Y₂O₃.Al₂O₃) (2)

This has perovskite crystal structure.
Y₄Al₂O₉ (YAM: 2Y₂O₃.Al₂O₃) (3)

This belongs to monoclinic system.

Additional components and impurities other than the yttria-alumina composite oxide are not excluded. However, a total content of the components other than the composite oxide may preferably be 10% by weight or less.

Furthermore, in the above ceramics containing alumina, the yttria-alumina composite oxide described above, a spinel type compound, a zirconium compound and a rare earth compound may be contained. In this embodiment, if the total content of the yttria-alumina composite oxide described above, a spinel type compound, a zirconium compound and a rare earth compound is too large, the thermal conductivity and the material strength may be lowered. Accordingly, the content is preferable to be 10% by weight or less in total, being further preferable to be in the range of 3 to 7% by weight.

In both of the ceramics containing alumina and yttria-alumina composite oxide, the powder mixture may contain powder of a third component. However, the third component is preferable not to be detrimental to the garnet phase and is preferable to be capable of replacing yttria or alumina in the garnet phase. As such components, the followings can be cited.

La₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃, MgO, CaO, SrO, ZrO₂, CeO₂, SiO₂, Fe₂O₃, and B₂O₃.

According to the sintered bodies of the first and second aspects of the present invention, the peeling may be prevented between the first and second phases, even when the area of the interface of the first and second phases is large. The present invention is thus suitable for the production of the sintered body having a large surface area. According to the process of the present invention, the sintered body having an area of the interface between the first and second phases of 100 cm² or more, for example 6400 cm², may be produced.

According to the first and second aspects of the present invention, it is produced a sintered body having at least first and second phases contacting each other at an interface. The manufacturing process of the sintered body is not particularly limited. The followings are preferred processes for producing the sintered body.

The first and second phases may be shaped by any processes, including gel cast molding, cold isostatic pressing, slip casting, slurry dipping, doctor blade and injection molding. The order of shaping of the first and second phases is not also limited.

In a preferred embodiment, either or both of the first and second phases is shaped by gel cast molding. Preferred examples relating to this embodiment will be described below.

According to the method, a slurry containing an inorganic sinterable powder, a dispersing medium and a gelling agent is cast into a mold, and the slurry is solidified by gellation to shape at least the first phase to obtain the sintered body.

This shaping process of the first phase is referred to as a gel cast molding process. According to the process, a slurry containing a powder of a ceramics or metal, a dispersing medium and gelling agent are molded and gelled with the addition of a crossing agent or adjustment of temperature so that the slurry is solidified to obtain a shaped body.

A gel cast molding process is known as a process for producing a shaped body of powder. However, it has not known to shape the first phase with gel cast molding in producing the shaped body having the first and second phases. It has not also known to co-fire the thus obtained shaped body to produce a sintered body having the first and second phases.

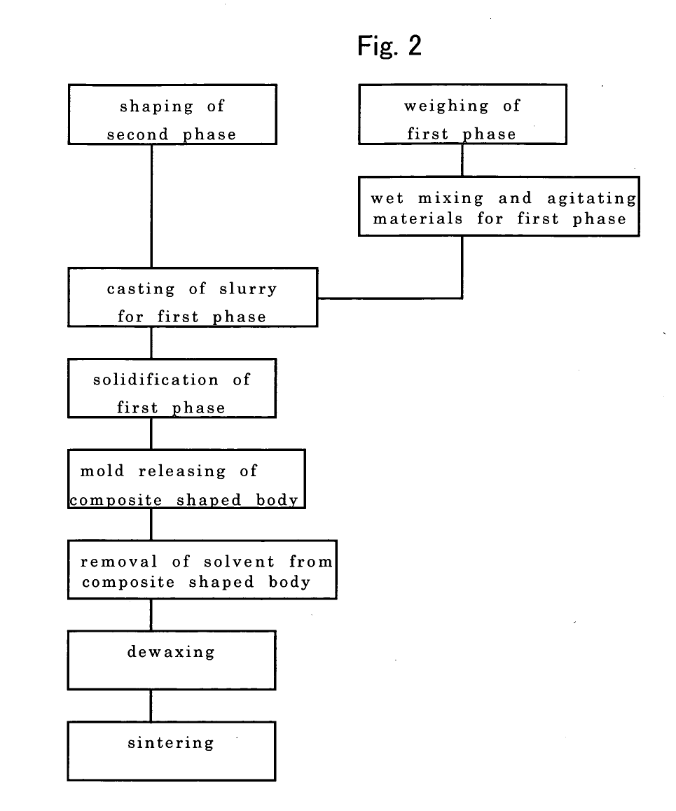

According to a preferred embodiment, as shown in FIG. 2, the second phase may be shaped in advance. That is, the second phase is shaped by gel cast molding or the other shaping process. The raw material of the first phase is weighed, wet mixed and agitated to obtain a slurry. The shaped body of the second phase is contained in a mold, into which the slurry for the first phase is supplied and solidified to produce a composite shaped body. The shaped body is removed from the mold. After the solvent and binder of the body are removed, the body is sintered.

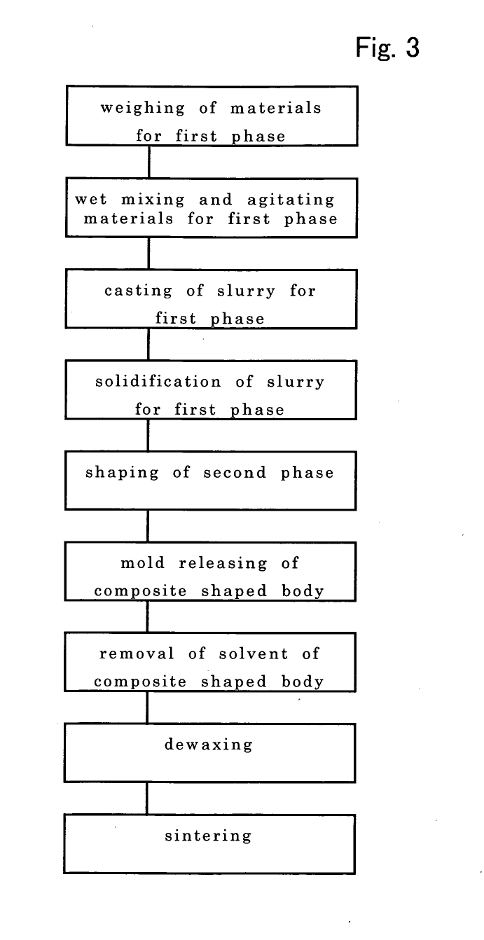

Alternatively, as shown in FIG. 3, the first phase may be shaped in advance. That is, the material of the first phase is weighed, wet mixed and agitated to obtain a slurry. The slurry for the first phase is supplied into a mold and solidified to obtain a shaped body for the first phase. The shaped body for the first phase is removed from the mold, and the second phase is then shaped to produce the composite shaped body.

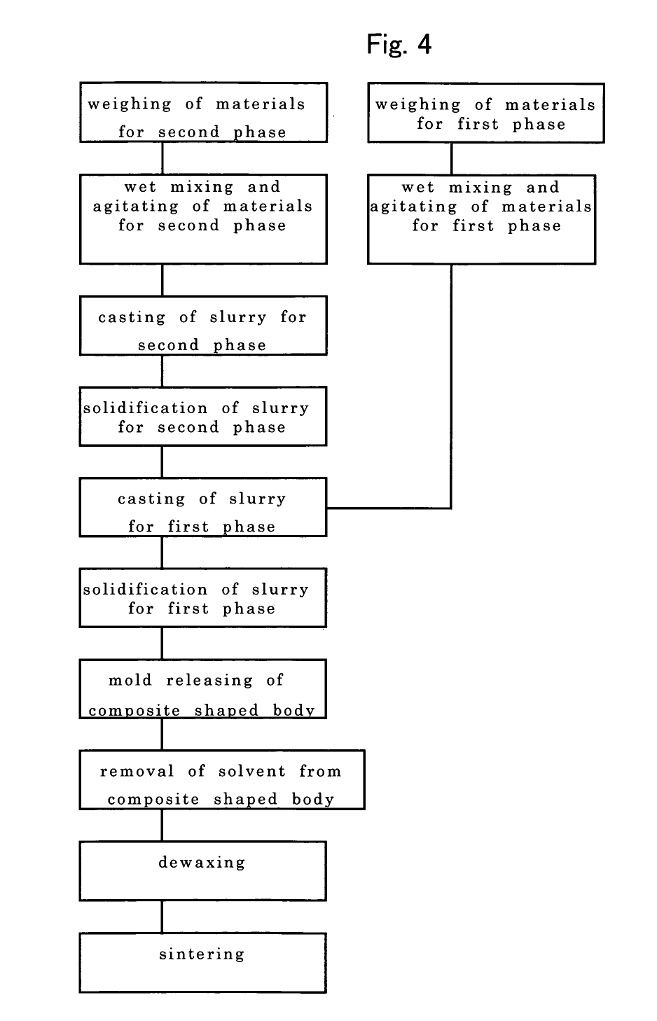

Most preferably, as shown in FIG. 4, the second phase is shaped by gel cast molding to obtained a shaped body, which is then contained in a mold. The slurry for the first phase is then supplied into the mold and shaped by gel cast molding. In this embodiment, the dimensional precisions of the sintered and shaped bodies of the present invention may be further improved, and the peel strength of the first and second phases in the sintered body can be considerably improved.

Gel casting process may be carried out as follows.

(1) A gelling agent and inorganic powder are dispersed in a dispersing agent to produce a slurry. The gelling agent includes polyvinyl alcohol and a prepolymer such as an epoxy resin and phenol resin. The slurry is then supplied into a mold and subjected to three dimensional cross linking reaction with a cross linking agent to solidify the slurry.

(2) An organic dispersing medium having a reactive functional group and a gelling agent are chemically bonded with each other to solidify the slurry. The process is described in Japanese patent publication 2001-335371A (US publication 2002-0033565).

According to the process, it is preferred to use an organic dispersing medium having two or more reactive functional groups. Further, 60 weight percent or more of the whole dispersing medium may preferably be an organic dispersing medium having a reactive functional group.

The organic dispersing medium having a reactive functional group may preferably have a viscosity of 20 cps or lower at 20° C. The gelling agent may preferably have a viscosity of 3000 cps or lower at 20° C. Specifically, it is preferred to react the organic dispersing medium having two or more ester bonds with the gelling agent having an isocyanate group and/or an isothiocyanate group to solidify the slurry.

An organic dispersing medium satisfies the following two conditions.

(1) The medium is a liquid substance capable of chemically reacting with the gelling agent to solidify the slurry.

(2) The medium is capable of producing the slurry with a high liquidity for the ease of supply into the mold.

The organic dispersing medium necessarily has a reactive functional group, such as hydroxyl, carboxyl and amino groups capable of reacting with the gelling agent in the molecule for solidifying the slurry.

The organic dispersing medium has at least one reactive functional group. The organic dispersing medium may preferably have two or more reactive functional groups for accelerating the solidification of the slurry.

The liquid substance having two or more reactive functional groups includes a polyalcohol (ex. A diol such as ethylene glycol, a triol such as glycerin or the like) and polybasic acid (dicarboxylic acid or the like).

It is not necessary that the reactive functional groups in the molecule may be the same or different kind of functional groups with each other. Further, many reactive functional groups may be present such as polyethylene glycol.

On the other hand, when a slurry with a high liquidity suitable for supply into a mold is produced, it is preferred to use a liquid substance having a viscosity as low as possible. The substance may preferably have a viscosity of 20 cps or lower at 20° C.

The above polyalcohol and polybasic acid may have a high viscosity due to the formation of hydrogen bonds. In this case, even when the polyalcohl or polybasic acid is capable of solidifying the slurry, they are not suitable as the reactive dispersing medium. In this case, it is preferred to use, as the organic dispersing medium, an ester having two or more ester bonds such as a polybasic ester (for example, dimethyl glutarate), or acid ester of a polyalcohol (such as triacetin).

Although an ester is relatively stable, it has a low viscosity and may easily react with the gelling agent having a high reactivity. Such ester may satisfy the above two conditions. Particularly, an ester having 20 or lower carbon atoms have a low viscosity, and may be suitably used as the reactive dispersing medium.

In the present embodiment, a non-reactive dispersing medium may be also used. The dispersing agent may preferably be an ether, hydrocarbon, toluene or the like.

Further, when an organic substance is used as the non-reactive dispersing agent, preferably 60 weight percent or more, more preferably 85 weight percent or more of the whole dispersing agent may be occupied by the reactive dispersing agent for assuring the reaction efficiency with the gelling agent.

The reactive gelling agent is described in Japanese patent publication 2001-335371A (US publication 2002-0033565).

Specifically, the reactive gelling agent is a substance capable of reacting with the dispersing medium to solidify the slurry. The gelling agent may be any substances, as long as it has a reactive functional group which may be chemically reacted with the dispersing medium. The gelling agent may be a monomer, an oligomer, or a prepolymer capable of cross linking three-dimensionally such as polyvinyl alcohol, an epoxy resin, phenol resin or the like.

The reactive gelling agent may preferably have a low viscosity of not larger than 3000 cps at 20° C. for assuring the liquidity of the slurry.

A prepolymer and polymer having a large average molecular weight generally have a high viscosity. According to the present invention, a monomer or oligomer having a lower molecular weight, such as an average molecular weight (GPC method) of not larger than 2000, may be preferably used.

Further, the “viscosity” means a viscosity of the gelling agent itself (viscosity of 100 percent gelling agent) and does not mean the viscosity of a commercial solution containing a gelling agent (for example, viscosity of an aqueous solution of a gelling agent).

The reactive functional group of the gelling agent may be selected considering the reactivity with the reactive dispersing medium. For example, when an ester having a relatively low reactivity is used as the reactive dispersing medium, the gelling agent having a highly reactive functional group such as an isocyanate group (—N═C═O) and/or an isothiocyanate group (—N═C═S) may be preferably used.

An isocyanate group is generally reacted with an diol or diamine. A diol generally has, however, a high viscosity as described above. A diamine is highly reactive so that the slurry may be solidified before the supply into the mold.

Taking such a matter into consideration, a slurry is preferable to be solidified by reaction of a reactive dispersion medium having ester bonds and a gelling agent having an isocyanate group and/or an isothiocyanate group. In order to obtain a further sufficient solidified state, a slurry is more preferable to be solidified by reaction of a reactive dispersion medium having two or more ester bonds and a gelling agent having isocyanate group and/or an isothiocyanate group.

Examples of the gelling agent having isocyanate group and/or isothiocyanate group are MDI (4,4′-diphenylmethane diisocyanate) type isocyanate (resin), HDI (hexamethylene diisocyanate) type isocyanate (resin), TDI (tolylene diisocyanate) type isocyanate (resin), IPDI (isophorone diisocyanate) type isocyanate (resin), and an isothiocyanate (resin).

Additionally, the other functional groups may preferably be introduced into the foregoing basic chemical structures while taking the chemical characteristics such as compatibility with the reactive dispersion medium and the like into consideration. For example, in the case of reaction with a reactive dispersion medium having ester bonds, it is preferable to introduce a hydrophilic functional group from a viewpoint of improvement of homogeneity at the time of mixing by increasing the compatibility with esters.

Further, reactive functional groups other than isocyanate and isothiocyanate groups may be introduced into a molecule, and isocyanate group and isothiocyanate group may coexist. Furthermore, as a polyisocyanate, a large number of reactive functional groups may exist together.

The slurry for shaping the first or second phase may be produced as follows.

(1) The inorganic powder is dispersed into the dispersing medium to produce the slurry, into which the gelling agent is added.

(2) The inorganic powder and gelling agent are added to the dispersing agent at the same time.

The slurry may preferably have a viscosity at 20° C. of 30000 cps or less, more preferably 20000 cps or less, for improving the workability when the slurry is filled into a mold. The viscosity of the slurry may be adjusted by controlling the viscosities of the aforementioned reactive dispersing medium and gelling agent, the kind of the powder, amount of the dispersing agent and content of the slurry (weight percent of the powder based on the whole volume of the slurry).

If the content of the slurry is too low, however, the density of the shaped body is reduced, leading to a reduction of the strength of the shaped body, crack formation during the drying and sintering steps and deformation due to the increase of the shrinkage. Normally, the content of the slurry may preferably be in a range of 25 to 75 volume percent, and more preferably be in a range of 35 to 75 volume percent, for reducing cracks due to the shrinkage during a drying process.

Further, various additives may be added to the slurry for shaping. Such additives include a catalyst for accelerating the reaction of the dispersing medium and gelling agent, a dispersing agent for facilitating the production of the slurry, an anti-foaming agent, a detergent, and a sintering aid for improving the properties of the sintering body.

The thus obtained shaped body is then sintered to produce the sintered body of the present invention. The sintering temperature, atmosphere, temperature ascending and descending rates, and a holding time period at the maximum temperature are to be decided depending on the materials constituting the shaped body. Generally, the maximum temperature during the sintering may preferably be in a range of 1300 to 2000° C. Further, when the ceramics containing an yttria-alumina composite oxide is to be sintered, the maximum temperature may preferably be in a range of 1400 to 1700° C.

### EXAMPLES

### Example 1

The composite sintered body 1 shown in FIG. 1(a) was produced. According to the present example, the first and second phases were continuously formed by gel cast molding process.

Specifically, 100 weight parts of alumina powder (“AES-11C” supplied by Sumitomo Denko Inc.)), 25 weight parts of dimethyl glutarate (reactive dispersing medium), 7 weight parts of aliphatic polyisocyanate (gelling agent), 5 weight parts of triethyl amine and 0.5 weight parts of polymaleic acid copolymer were mixed in a pot mill to obtain a slurry for an alumina substrate. The slurry was filled in a mold, and stood for a specific time period so that the slurry was gelled and solidified to produce the shaped portion for the alumina substrate. The designed value of the thickness of the alumina substrate was changed as shown in Table 1. The added amount of 8 mole percent yttria-stabilized zirconia with respect to 100 weight parts of the alumina powder was changed as shown in Table 1.

Further, 100 weight parts of yttrium-aluminum garnet powder, 25 weight parts of dimethyl glutarate (reactive dispersing medium), 7 weight parts of an aliphatic polyisocyanate (gelling agent), 5 weight parts of triethyl amine and 0.5 weight parts of polymaleic acid copolymer were weighed and mixed in a pot mill to obtain a slurry for a YAG film. The slurry was then filled in a mold and solidified to obtain a shaped portion for the YAG film. The designed value of thickness for the YAG film was changed as shown in Table 1.

The thus obtained composite shaped body was removed from the mold, and heat treated at 250° C. for 5 hours to remove the solvent, dewaxed at 1000° C. for 2 hours, and then sintered at 1600° C. for 6 hours to obtain a composite sintered body.

The thus obtained sintered body was measured for the diameters of particles constituting the respective phases. Specifically, the broken surface or polished cross section of the material for each phases was measured by means of a scanning type electron microscope. The magnitudes of the photograph in vertical and horizontal axes were enlarged to ×3000 to ×5000 so that the vertical and horizontal dimensions of the image were finally enlarged to 200 mm or larger and 100 mm or larger, respectively. Four straight lines were drawn crossing a side of the photograph 200 mm or longer and two straight lines were drawn crossing a side of the photograph of 100 mm or longer, so that a distance between the adjacent straight lines was adjusted to 50 mm. Each straight line passes across a target grain and intersects the intergranular phase surrounding the target grain at two points in the photograph. The diameter of the target grain is defined as a distance of the two points where the straight line intersects the intergranular phase.

Ten sintered bodies were produced for each of the above examples. Cracks and peeling were observed by means of visual evaluation and red check for each sample to calculate the incidence of the cracks and peeling. The results were shown in table 1.

TABLE 1

| | | | | | | | | Incidence |
|---|---|---|---|---|---|---|---|---|
| | Area of interface | First phase | | | | Second phase | | of cracks |
| | between first | Alumina + Zirconia | | | | (YAG) | | peeling |
| Experi- | and second | Stabilizer | Added amount | | 0.2-3 μm | | 0.3-3 μm | (Number |
| ment | phases | of | of zirconia | Thickness | ratio | Thickness | ratio | of occurence/ |
| Number | (cm2) | Zirconia | (weight %) | (mm) | (%) | (mm) | (%) | samples) |
| 1 | 25 | | None | 5 | 0 | 0.5 | 95 | 10/10 |
| 2 | 25 | | None | 5 | 30 | 0.5 | 95 | 10/10 |
| 3 | 25 | 8molY203 | 10 | 5 | 50 | 0.5 | 95 | 9/10 |
| 4 | 25 | 8molY203 | 20 | 5 | 95 | 1 | 50 | 10/10 |
| 5 | 25 | 8molY203 | 20 | 5 | 95 | 1 | 70 | 10/10 |
| 6 | 25 | 8molY203 | 12 | 5 | 80 | 1 | 80 | 0/10 |
| 7 | 25 | 8molY203 | 15 | 5 | 94 | 1 | 95 | 0/10 |
| 8 | 25 | 8molY203 | 20 | 10 | 95 | 2 | 95 | 0/10 |
| 9 | 25 | 8molY203 | 25 | 20 | 100 | 5 | 95 | 0/10 |
| 10 | 25 | 8molY203 | 30 | 25 | 100 | 5 | 95 | 0/10 |
| 11 | 25 | 8molY203 | 35 | 30 | 100 | 5 | 95 | 0/10 |

In the test numbers 1, 2 and 3, the ratio of particles having diameters in a range of 0.2 to 3 μm was 50 percent or lower in the first phase, and the incidence of cracks and peeling was proved to be high. In the test numbers 4 and 5, the ratio of particles having diameters in a range of 0.3 to 3 μm was lower than 80 percent in the second phase, and the incidence of cracks and peeling was proved to be high. In the test numbers 6, 7, 8, 9, 10 and 11, the ratio of particles having diameters in a range of 0.2 to 3 μm was 80 percent or higher in the first phase and the ratio of particles having diameters in a range of 0.3 to 3 μm was 80 percent or higher in the second phase, and the incidence of cracks and peeling was proved to be low.

### Example 2

The composite sintered body 1 shown in FIG. 1(a) was produced. According to the present example, the first and second phases were continuously formed by gel cast molding process.

Specifically, 100 weight parts of silicon carbide powder, 25 weight parts of dimethyl glutarate (reactive dispersing medium), 7 weight parts of aliphatic polyisocyanate (gelling agent), 5 weight parts of triethyl amine and 0.5 weight parts of polymaleic acid copolymer were mixed in a pot mill to obtain a slurry. The slurry was filled in a mold, and stood for a specific time period so that the slurry was gelled and solidified to produce a shaped body for a substrate. The designed value of the thickness of the substrate was changed as shown in Table 2. The added amount of boron nitride powder with respect to 100 weight parts of silicon carbide powder was changed as shown in Table 2.

Further, 100 weight parts of silicon carbide powder, 25 weight parts of dimethyl glutarate (reactive dispersing medium), 7 weight parts of an aliphatic polyisocyanate, 5 weight parts of triethyl amine and 0.5 weight parts of polymaleic acid copolymer were weighed and mixed in a pot mill to obtain a slurry for a film. The slurry was then filled in a mold and solidified to obtain a shaped portion for the film. The designed value of thickness for the film was changed as shown in Table 2. The added amount of carbon powder with respect to 100 weight parts of the carbide powder was changed as shown in Table 2.

The thus obtained composite shaped body was removed from the mold, heat treated at 250° C. for 5 hours to remove the solvent, dewaxed at 1000° C. for 2 hours, and then sintered at 1600° C. for 6 hours to obtain a composite sintered body.

Ten sintered bodies were produced for each of the above examples. Cracks and peeling were observed by means of visual evaluation and red check for each sample to calculate the incidence of the cracks and peeling. The results were shown in table 2.

TABLE 2

| | | | | | | | | Incidence |
|---|---|---|---|---|---|---|---|---|
| | Area of interface | First phase | | | Second phase | | | of cracks |
| | between first | SiC + BN | | | SiC + C | | | peeling |
| Experi- | and second | Added amount | | 0.2-3 μm | C | | 0.3-3 μm | (Number |
| ment | phases | of BN | Thickness | ratio | Added | Thickness | ratio | of occurence/ |
| Number | (cm2) | (weight %) | (mm) | (%) | Amount | (mm) | (%) | samples |
| 12 | 25 | None | 5 | 50 | None | 0.5 | | 10/10 |
| 13 | 25 | 0.5 | 5 | 55 | 5 | 0.5 | | 9/10 |
| 14 | 25 | 1 | 5 | 70 | 5 | 1 | | 5/10 |
| 15 | 25 | 2 | 10 | 80 | 5 | 2 | | 0/10 |
| 16 | 25 | 4 | 15 | 100 | 5 | 3 | | 0/10 |
| 17 | 25 | 4 | 15 | 100 | 0.5 | 3 | | 10/10 |
| 18 | 25 | 4 | 15 | 100 | 1 | 3 | | 10/10 |
| 19 | 25 | 4 | 15 | 100 | 3 | 3 | | 7/10 |

In the test numbers 12, 13 and 14, the ratio of particles having diameters in a range of 0.2 to 3 μm was 70 percent or lower in the first phase, and the incidence of cracks and peeling was proved to be high. In the test numbers 17, 18 and 19, the ratio of particles having diameters in a range of 0.3 to 3 μm was lower than 80 percent in the second phase, and the incidence of cracks and peeling was proved to be high. In the test numbers 15 and 16, the ratio of particles having diameters in a range of 0.2 to 3 μm was 80 percent or higher in the first phase and the ratio of particles having diameters in a range of 0.3 to 3 μm was 80 percent or higher in the second phase, and the incidence of cracks and peeling was proved to be low.

The present invention has been explained referring to the preferred embodiments, however, the present invention is not limited to the illustrated embodiments which are given by way of examples only, and may be carried out in various modes without departing from the scope of the invention.

1. A ceramic sintered body comprising first and second phases contacting each other, said first phase having a thickness larger than that of said second phase, wherein 80 percent or more of particles constituting said first phase have diameters in a range of 0.2 to 3 μm, and wherein 80 percent or more of particles constituting said second phase have diameters in a range of 0.3 to 3 μm

2. The ceramic sintered body of claim 1, wherein said first phase comprises a ceramics containing alumina and said second phase comprises a ceramics containing an yttria-alumina composite oxide.

3. The ceramic sintered body of claim 2, wherein said first phase comprises a ceramics containing alumina and zirconia, and wherein said second phase contains an yttrium-aluminum garnet.

4. The ceramic sintered body of claim 1, wherein said first and second phases contact at an interface having an area of 25 cm² or larger, and wherein a total of said thickness of said first phase and that of said second phase is 1 mm or larger.

5. A ceramic sintered body comprising first and second phases contacting each other, said first phase having a fracture strength larger than that of said second phase, wherein 80 percent or more of particles constituting said first phase have diameters in a range of 0.2 to 3 μm, and wherein 80 percent or more of particles constituting said second phase have diameters in a range of 0.3 to 3 μm.

6. The ceramic sintered body of claim 5, wherein said first phase comprises a ceramics containing alumina and said second phase comprises a ceramics containing an yttria-alumina composite oxide.

7. The ceramic sintered body of claim 6, wherein said first phase comprises a ceramics containing alumina and zirconia, and wherein said second phase contains an yttrium-aluminum garnet.

8. The ceramic sintered body of claim 5, wherein said first and second phases contact at an interface having an area of 25 cm² or larger, and wherein a total of said thickness of said first phase and that of said second phase is 1 mm or larger.
